(19) United States
(12) Patent Application Publication
(10) Pub. No.: US 2014/0289486 A1
(43) Pub. Date: Sep. 25, 2014

(54) INFORMATION PROCESSING APPARATUS, INFORMATION PROCESSING METHOD, AND RECORDING MEDIUM

(71) Applicant: SONY CORPORATION, Tokyo (JP)

(72) Inventors: Tomohiro KATORI, Tokyo (JP); Satoru IWASAKI, Tokyo (JP)

(73) Assignee: SONY CORPORATION, Tokyo (JP)

(21) Appl. No.: 14/186,066

(22) Filed: Feb. 21, 2014

(30) Foreign Application Priority Data
Mar. 25, 2013 (JP) 2013-061949

(51) Int. Cl. G06F 3/06

(52) U.S. Cl. CPC G06F 3/065; G06F 3/0604; G06F 3/0683
USPC 711/162

(57) ABSTRACT

An information processing apparatus includes a main storage device, and a secondary storage device, in which the main storage device includes a non-volatile storage unit and a volatile storage unit, the volatile storage unit has a synchronization area that is synchronized with a predetermined area of the secondary storage device, and a page placed in the synchronization area is synchronized with the secondary storage device to be stored during an operation of the volatile storage unit.

### CROSS REFERENCE TO RELATED APPLICATIONS

This application claims the benefit of Japanese Priority Patent Application JP 2013-061949 filed Mar. 25, 2013, the entire contents of which are incorporated herein by reference.

### BACKGROUND

The present technology relates to an information processing apparatus, an information processing method, and a recording medium. Specifically, the present technology relates to an information processing apparatus capable of shortening time for transition to a state such as a suspend state or the like, an information processing method, and a recording medium.

Various types of personal computers such as desktop computers, notebook computers and tablet computers, smartphones, and mobile terminals have come into wide use. The personal computers such as notebook computers and tablet computers, mobile terminals and the like are a battery driven type which also can be driven by a battery included therewithin, and have structures that can be being carried easily.

A battery driving time is limited and various methods for power saving have been proposed to extend the battery driving time. The power saving has been realized not only for the mobile terminals but also for the desktop personal computers.

As one method for power saving, a method in which power supply to a part or the entire system is properly reduced or cut off in response to a reduction in a system usage situation can be considered. However, since a task is interrupted from power cutoff, it is necessary to save system state information before the power is cut off and restore the saved state information when the power is re-supplied so that the task can be restarted from the time point at which the task has been interrupted when the power is re-supplied. An operation of saving the system state information and interrupting the task is referred to as “suspend” and an operation of restoring the state information and restarting the task is referred to as “resume.”

There may be two methods for realizing the suspend and resume functions. One is a method in which power is continuously supplied to a volatile main storage device or the like before and after the power of a terminal is cut off to hold system state information. In addition, the other is a method in which, when power is cut off, system state information that is decompressed in a main storage device or the like is stored in a non-volatile secondary storage device and the saved state information is restored in the main storage device or the like when the power is re-supplied.

In the former method, the system state information is stored in the battery-backed-up volatile main storage device or the like. Therefore, saving and restoration processes of the terminal are performed at a very high speed, but the power is consumed for a memory holding operation by the main storage device when the terminal is stopped. Thus, a power saving effect is low. On the other hand, in the latter case, since the system state information necessary for restarting a task is stored in the non-volatile secondary storage device, the power can be cut off in almost all of components in the terminal and a power saving effect is high.

However, the access rate of a hard disk drive (or a flash memory) as the secondary storage device is generally lower than that of the main storage device. If a process operation of storing or decompressing a memory image in the main storage device in the secondary storage device is included, a defect such as the operation taking too much time occurs.

As described above, since the main storage device of the system is volatile, it is necessary to save the content of the main storage device in the secondary storage device to transit the system state to a suspend state by cutting off the entire power of the system including the main storage device (process referred to as suspend to disk or hibernation).

Contrarily, there has been proposed a method in which time necessary for a suspend process is shortened by using a non-volatile device in a part of a main storage device without saving data in a non-volatile storage unit (for example, refer to Japanese Unexamined Patent Application Publication No. 2004-362426).

### SUMMARY

In Japanese Unexamined Patent Application Publication No. 2004-362426, the priority is assigned to pages that are necessary for a resume process and the pages are moved to a non-volatile storage unit in descending order of priority during suspend execution. At this time, pages, which are not able to be stored in the non-volatile storage unit and overflow, are moved to a secondary storage device. Then, in the resume process, the pages stored in the secondary storage device are read by a volatile storage unit.

However, in Japanese Unexamined Patent Application Publication No. 2004-362426, since paging is performed from the volatile storage unit to the non-volatile storage unit or the secondary storage device during the suspend execution, it is difficult to shorten time to save the pages. For example, if there are a large number of pages placed in the volatile storage unit, there are a large number of pages to be moved during the suspend process and it takes a long time to move the pages. Therefore, it is difficult to shorten time to save the pages.

Since an effect of power saving or the like can be expected by shortening time for a suspend process, shortening time for the suspend process has been demanded.

It is desirable to shorten time for a suspend process.

According to an embodiment of the present technology, there is provided an information processing apparatus including a main storage device, and a secondary storage device, in which the main storage device includes a non-volatile storage unit and a volatile storage unit, the volatile storage unit has a synchronization area that is synchronized with a predetermined area of the secondary storage device, and a page placed in the synchronization area is synchronized with the secondary storage device to be stored during an operation of the volatile storage unit.

The page placed in the synchronization area may be a page that is necessary to be saved in the secondary storage device before a suspend process ends.

The information processing apparatus may further include a first list for managing pages which are stored in the non-volatile storage unit, and a second list for managing pages which are synchronized with the volatile storage unit and the secondary storage device to be stored.

The information processing apparatus may further include a third list for managing the pages stored in the secondary storage device.

The pages may be sorted to any one of the first list, the second list, and the third list according to a rewriting frequency with respect to the pages.

When the page managed in the second list or the third list is rewritten, the rewritten page may be changed to the page to be managed in the first list to be moved in the non-volatile storage unit.

The information processing apparatus may further include a fourth list for managing pages stored in a saving target area, the volatile storage unit may have the saving target area for storing a page which is a page having the highest rewriting frequency and is stored in the non-volatile storage unit during a suspend process, and the non-volatile storage unit may have an area for saving in which the page stored in the saving target area is stored during the suspend process.

When a page managed in any one of the first list to the third list is rewritten, the rewritten page may be changed to a page managed in the fourth list and moved to the saving target area.

According to another embodiment, there is provided an information processing method of an information processing apparatus that includes a main storage device, and a secondary storage device, the main storage device having a non-volatile storage unit and a volatile storage unit, including providing a synchronization area that is synchronized with a predetermined area of the secondary storage device in the volatile storage unit, and synchronizing a page placed in the synchronization area with the secondary storage device to be stored during an operation of the volatile storage unit.

According to still another embodiment, there is provided a computer-recording recording medium having a program recorded therein, the program causing a computer, which controls an information processing apparatus that includes a main storage device, and a secondary storage device, the main storage device having a non-volatile storage unit and a volatile storage unit, to execute a process including providing a synchronization area that is synchronized with a predetermined area of the secondary storage device in the volatile storage unit, and synchronizing a page placed in the synchronization area with the secondary storage device to be stored during an operation of the volatile storage unit.

In the information processing apparatus, the information processing method, and the recording medium according to the embodiments of the present technology, the main storage device and the secondary storage device are provided, and the main storage device includes the non-volatile storage unit and the volatile storage unit. In the volatile storage unit, the synchronization area that is synchronized with a predetermined area of the secondary storage device is provided and the page placed in the synchronization area is synchronized with the secondary storage device to be stored during an operation of the volatile storage unit.

According to the embodiments of the present technology, it is possible to shorten time for a suspend process.

### BRIEF DESCRIPTION OF THE DRAWINGS

FIG. 1 is a diagram illustrating an example of an information processing apparatus in the related art;

FIG. 2 is a flow chart for illustrating a suspend process in the related art;

FIG. 3 is a diagram illustrating a configuration of an embodiment of an information processing apparatus to which the present technology is applied;

FIG. 4 is a diagram illustrating a function of the information processing apparatus;

FIGS. 5A and 5B are diagrams for illustrating saving of pages during a suspend process;

FIG. 6 is a flow chart for illustrating the suspend process;

FIG. 7 is a diagram illustrating another configuration of the information processing apparatus;

FIG. 8 is a diagram for illustrating a page synchronization;

FIG. 9 is a diagram illustrating a relationship between pages and lists;

FIG. 10 is a diagram for illustrating a page movement;

FIG. 11 is a diagram for illustrating transition among the lists;

FIG. 12 is a diagram for illustrating changes in a data configuration during a page movement;

FIG. 13 is a flow chart for illustrating a process when a page is rewritten;

FIG. 14 is a flow chart for illustrating a process when a page is rewritten;

FIG. 15 is a diagram for illustrating still another configuration of the information processing apparatus;

FIG. 16 is a diagram for illustrating a page movement;

FIG. 17 is a diagram illustrating a relationship between pages and lists;

FIG. 18 is a diagram for illustrating transition among the lists;

FIG. 19 is a flow chart for illustrating a suspend process; and

FIG. 20 is a diagram for illustrating a recording medium.

### DETAILED DESCRIPTION OF EMBODIMENTS

Embodiments for carrying out the present technology (hereinafter, referred to as “embodiments”) will be described hereinafter. Description will be made in the following order.

1. Suspend Process in Related Art

2. Configuration of Information Processing Apparatus according to First Embodiment to which Present Technology is Applied

3. Suspend Process in First Embodiment

4. Configuration of Information Processing Apparatus according to Second Embodiment

5. Page Movement and List Update in Second Embodiment

6. Configuration of Information Processing Apparatus according to Third Embodiment

7. Suspend Process in Third Embodiment

8. Regarding Other Configurations

9. Regarding Recording Medium

### Suspend Process in Related Art

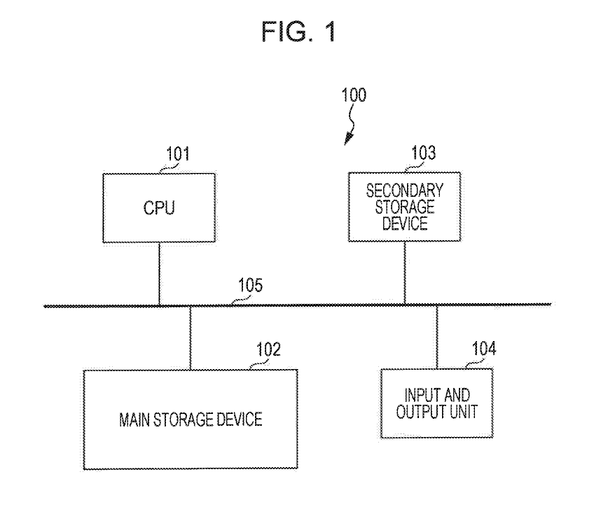

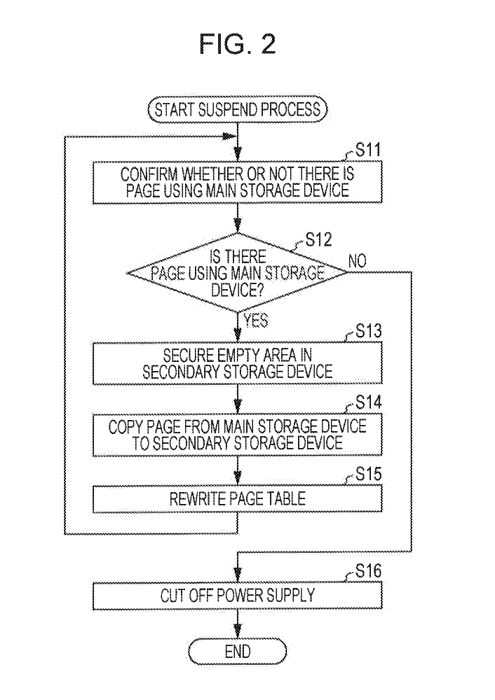

First, an information processing apparatus of the related art and a suspend process in the information processing apparatus will be described to clear the difference between the present technology and the related art. FIG. 1 is a diagram illustrating a configuration of the information processing apparatus of the related art, and FIG. 2 is a flow chart for illustrating a suspend process in the information processing apparatus illustrated in FIG. 1.

The information processing apparatus 100 illustrated in FIG. 1 includes a central process unit (CPU) 101, a main storage device 102, a secondary storage device 103, an input and output unit 104, and a system bus 105.

The CPU 101 executes various types of programs under the control of an operating system (OS). The CPU 101 controls each unit in the information processing apparatus 100 through the system bus 105 which is a common signal transmission path formed of a data signal line, an address signal line, a control signal line, and the like.

The main storage device 102 loads each program (OS, application program or the like) executed by the CPU 101 or is used as an operation area by the CPU 101. The secondary storage device 103 is configured with a non-volatile storage unit such as a hard disk drive (HDD) or a flash memory. The access rate of the secondary storage device 103 is lower than that of the main storage device 102, but the secondary storage device has a large capacity and is provided to assist the main storage device 102.

The HDD is an external storage unit in which a magnetic disk is mounted in a fixed manner and is superior to other disk type storage devices such as a CD, a DVD and the like in terms of a storage capacity and data transfer rate. Usually, program codes of an operating system, an application program, a device driver, and the like, which are to be executed by the CPU 101, are stored in the HDD in a non-volatile mariner.

The input and output unit 104 includes a user input device such as a keyboard or a mouse, an output device such as a display and a printer, a connection interface with a network device, other external devices thereof, and the like. Drawing data on a display is once written in a video RAM (VRAM) (not illustrated) and then, output on the display.

A unique address (I/O address) in an I/O space is allocated to each device on the system bus 105, and access to each device is realized by designating the I/O address. In addition, a bus interface of each device includes an I/O register (not illustrated), and data or a command to be written to each device, data to be read from each device, device state, and the like are once written to the I/O register and then, bus transfer is performed.

In the configuration of the information processing apparatus 100 illustrated in FIG. 1, configurations necessary for the following description is illustrated and configurations for realizing other functions are not illustrated.

With reference to the flow chart in FIG. 2, the suspend process in the information processing apparatus 100 illustrated in FIG. 1 will be described.

In Step S11, a managed page table is confirmed and it is confirmed whether or not there is a virtual page using the main storage device 102. In Step S12, as a result of the confirmation in Step S11, it is determined whether or not there is the virtual page using the main storage device 102. In Step S12, if it is determined that there is the virtual page using the main storage device 102, the process proceeds to Step S13. If the virtual page using the main storage device 102 is found, a process for saving the page in the secondary storage device 103 starts.

In Step S13, an empty area in the secondary storage device 103 is secured to save the virtual page using the main storage device 102. For example, the empty area in the secondary storage device 103 is secured such that a swap management function of the operating system searches an unused area for one page from a swap area,

In Step S14, the page using the main storage device 102 is saved in the secured empty area in the secondary storage device 103. For example, the above-described swap management function is performed by copying the page to the secured empty area

In Step S15, the page table is updated and a virtual address mapping the saved page is invalidated. Further, the saved page is released and is recognized as an empty area.

By repeating the processes from Step S11 to Step S15 until there is no page using the main storage device 102, the pages using the main storage device 102 are saved.

Then, in Step S12, if it is determined there is no page using the main storage device 102, the process proceeds to Step S16 to cut off the power of the system.

The suspend process is performed as described above, and the saved data is returned to the main storage device 102 from the secondary storage device 103 during resume execution to thereby restore the system to a state before the power is cut off.

Since the suspend process is performed as described above, in a case in which the amount of data using the main storage device 102 is large when the suspend process starts, it takes a long time to save data using the secondary storage device 103. That is, if the process in Step S13 or Step S14 is repeated, it takes time to end the suspend process.

For example, if a user gives a suspend instruction and tries to confirm that the power is cut off, it takes a long time from the instruction to the power cutoff, and thus, the user may possibly become impatient. In addition, if the user gives the suspend instruction erroneously, a resume instruction is given after the suspend execution ends. After the system is restored to the state before suspend execution starts, it is determined that correct instructions are given. However, it takes time during the processes, and thus, the user may possibly become impatient similar to the above-described case.

Further, if the time when the information processing apparatus 100 is not used is set as a suspend state, a power saving effect can be expected. However, if it takes time until the suspend process ends, the power saving effect thereof is attenuated. For this reason, there is a possibility that the suspend execution itself may not be used. Therefore, it is possible to reduce these possibilities by shortening time for the suspend execution. Then, the embodiment of the present technology that can shorten time for the suspend process will be described below. Configuration of Information Processing Apparatus according to First Embodiment to which Present Technology is Applied

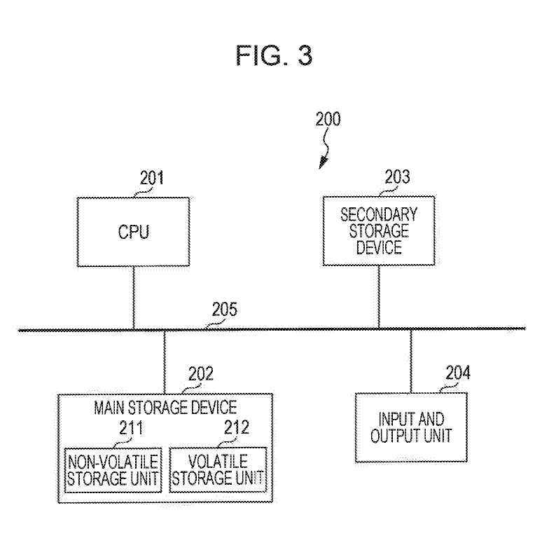

FIG. 3 is a diagram illustrating a hardware configuration of an information processing apparatus according to a first embodiment to which the present technology is applied. The information processing apparatus 200 illustrated in FIG. 3 includes a CPU 201, a main storage device 202, a secondary storage device 203, an input and output unit 204, and a system bus 205. In addition, the main storage device 202 of the information processing apparatus 200 illustrated in FIG. 3 has a non-volatile storage unit 211 and a volatile storage unit 212.

Examples of the information processing apparatus 200 include various types of personal computers such as desktop computers, notebook computers and tablet computers, smart phones, and mobile terminals.

The CPU 201 executes various types of programs under the control of an operating system (OS). The CPU 201 controls each unit in the information processing apparatus 200 through the system bus 205 which is a common signal transmission path formed of a data signal line, an address signal line, and a control signal line.

The main storage device 202 loads each program (OS, application program or the like) executed by the CPU 201 or is used as an operation area by the CPU 201. The secondary storage device 203 is configured with a non-volatile storage unit such as a hard disk drive (HDD) or a flash memory. The access rate of the secondary storage device 203 is lower than that of the main storage device 202, but the secondary storage device has a large capacity and is provided to assist the main storage device 202.

The input and output unit 204 includes a user input device such as a keyboard or a mouse, an output device such as a display or a printer, a connection interface with a network device and other external devices thereof, and the like. Drawing data on a display is once written in a video RP (VRAM) (not illustrated) and then, output on the display.

A unique address (I/O address) in an I/O space is allocated to each device on the system bus 205, and access to each device is realized by designating the I/O address. In addition, a bus interface of each device includes an I/O register (not illustrated), and data or a command to be written to each device, data to be read from each device, a device state, and the like are once written to the I/O register and then, bus transfer is performed.

In the configuration of the information processing apparatus 200 illustrated in FIG. 2, configurations necessary for the following description is illustrated and configurations for realizing other functions is not illustrated.

The information processing apparatus 100 illustrated in FIG. 1 is compared with the information processing apparatus 200 illustrated in FIG. 3. The main storage device 102 of the information processing apparatus 100 of the related art illustrated in FIG. 1 is different from the main storage device 202 of the information processing apparatus 200 illustrated in FIG. 3 in that while the main storage device 120 is configured with the volatile storage unit, the main storage device 202 is configured with the non-volatile storage unit 211 and the volatile storage unit 212.

The non-volatile storage unit 211 is an area in the main storage device 202 in which data does not disappear even when the power of the information processing apparatus 200 is cut off. Specifically, a device using a non-volatile memory element such as a MRAM or a ReRAM may be used.

The magnetic RAM (MRAM) is configured with a tunneling magneto resistive (TMR) element using a tunneling magneto resistive effect and is capable of holding information by using spin of electrons instead of using electric charge of electrons. The MRAM satisfies most of conditions as the main storage device 202 in terms of an access rate of rewriting, reading or the like, a degree of integration, power consumption, unit of bits or the like, and also has a feature of non-volatility.

In addition, the resistance RAM (ReRAM) is a non-volatile memory that uses a change in electric resistance by voltage application, and since rewriting is performed by voltage (the amount of current is very small), power consumption is low. Also, since a cell area is small and densification can be achieved, the ReRAM satisfies most of conditions as the main storage device similar to the MRAM. Accordingly, specifically, the device using the non-volatile memory element such as the MRAM or the ReRAM is used in the non-volatile storage unit 211 of the main storage device 202, but it should be noted that the configuration is merely an example and the configuration is not limited thereto.

Further, the non-volatile storage unit can also be realized by attaching a backup battery to a device using a volatile memory element such as a dynamic random access memory (DRAM) as the non-volatile storage unit 211 of the main storage device 202.

Unlike the non-volatile storage unit 211, the volatile storage unit 212 is an area in the main storage device 202 in which data disappears when the power of the information processing apparatus 200 is cut off.

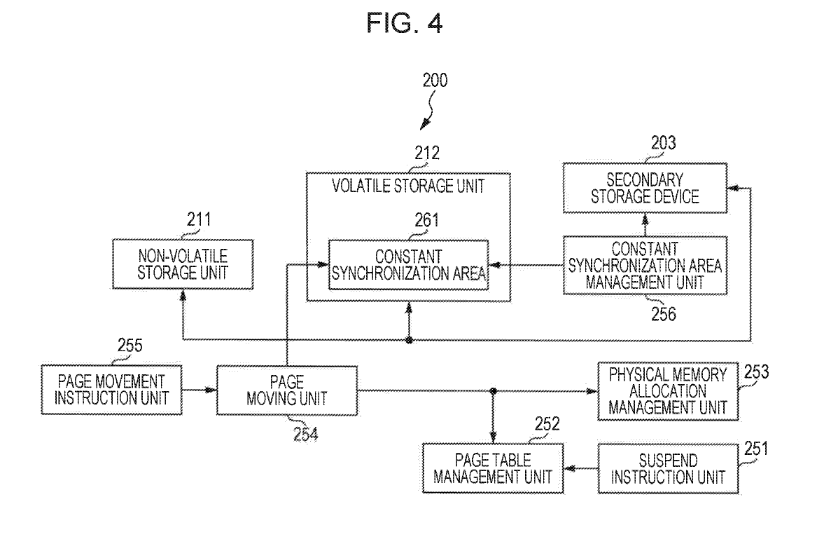

FIG. 4 is a functional block diagram of the information processing apparatus 200 having the hardware configuration illustrated in FIG. 3. The hardware configuration of the information processing apparatus 200 illustrated in FIG. 4 is illustrated together with functions that are realized by executing a predetermined program by the CPU 201.

The information processing apparatus 200 illustrated in FIG. 4 includes the secondary storage device 203, the non-volatile storage unit 211, the volatile storage unit 212, a suspend instruction unit 251, a page table management unit 252, a physical memory allocation management unit 253, a page moving unit 254, a page movement instruction unit 255, a constant synchronization area management unit 256, and a constant synchronization area 261.

The secondary storage device 203, the non-volatile storage unit 211, and the volatile storage unit 212 are the secondary storage device 203, the non-volatile storage unit 211, and the volatile storage unit 212 illustrated in FIG. 3. The secondary storage device 203 is a device such as a flash memory or a hard disk which continuously holds data even when the power is cut off. The storage capacity of the secondary storage device 203 may be larger than that of the normal main storage device 202, and the access rate may be lower.

The secondary storage device 203 is an area in which permanent data such as a file system or a data base is stored. In addition, data that is not able to be stored in the main storage device 202 during the operation of the system is saved or data held by the constant synchronization area 261 is copied to be stored by providing an area (hereinafter, appropriately, referred to as a swap area) for saving information on the main storage device 202 in the secondary storage device 203.

When the user gives a suspend instruction by operating the input and output unit 204 (FIG. 3), the suspend instruction unit 251 notifies the start of a suspend process to a place in which the suspend process is to be performed.

The page table management unit 252 manages a page table for mapping a physical address and a virtual address. The page table is a reference table for converting a virtual address to a physical address by a memory management unit (MMU), and plural page tables are present in every virtual address space.

When the page moving unit 254 moves a page, the page table management unit 252 receives physical addresses of a movement source and a movement destination of the page to update data of the page table mapping the physical addresses. When the start of the suspend process is notified by the suspend instruction unit 251, the page table management unit 252 makes a virtual address mapping the volatile storage unit 212 invalidated.

The physical memory allocation management unit 253 manages which page is being used and which page is empty in the physical memory. When the page moving unit 254 moves the pages, the physical memory allocation management unit 253 secures the movement destination pages from the empty area to notify the position to the page moving unit 254. After the movement is completed, the movement source pages become empty areas.

The page moving unit 254 moves data of a page designated by the page movement instruction unit 255 to another area in the main storage device 202 or to the secondary storage device 203. For example, data of a predetermined page is copied to non-volatile storage unit 211 from the volatile storage unit 212, and the page moving unit requests the physical memory allocation management unit 253 to release a memory of a copy source and use a memory of a copy destination. According to the page movement, the physical addresses of the movement source and the movement destination are notified to the page table management unit 252.

The page movement instruction unit 255 gives an instruction to the page moving unit 254 to move the data to the main storage device 202.

The constant synchronization area management unit 256 performs a process for synchronizing the page, which is being used and not yet synchronized with the secondary storage device 203 in the constant synchronization area 261 provided in the volatile storage unit 212, with the secondary storage device 203. The data of the page is copied to an area for saving data of the main storage device 202 of the secondary storage device 203.

The constant synchronization area 261 is provided in the volatile storage unit 212. The constant synchronization area 261 is an area that is determined to be synchronized with the secondary storage device 203 in the volatile storage unit 212 at all times. The constant synchronization area 261 can be set as an area formed by allocating a predetermined area of the volatile storage unit 212 in a fixed manner. Alternatively, for example, the operating system can attach a flag indicating whether or not an area is the constant synchronization area 261 to every page (a unit for managing the memory) to set the area to be logically determined.

Temporary data which is necessarily saved during the suspend process in a normal state (for example, data of a memory that is dynamically secured by an application) in the data placed in the volatile storage unit 212 is placed in the constant synchronization area 261. In areas other than the constant synchronization area 261 of the volatile storage unit 212, data which is not necessarily saved (for example, a cache of file data) is placed.

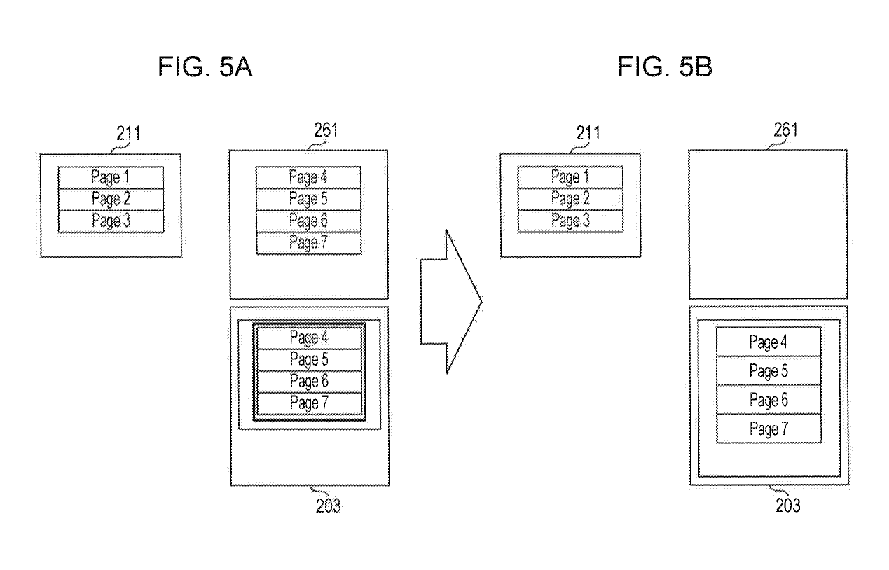

As described above, the information processing apparatus 200 according to the embodiment has the non-volatile storage unit 211 and the volatile storage unit 212 in the main storage device 202, and the constant synchronization area 261 is provided in the volatile storage unit 212. When the suspend process starts, the data that is moved from the volatile storage unit 212 to the secondary storage device 203 is written in the constant synchronization area 261 regardless of the suspend process. With regard to this, a description will be made with reference to FIGS. 5A and 5B.

FIG. 5A illustrates data that is respectively stored in the non-volatile storage unit 211, the constant synchronization area 261 and the secondary storage device 203 when (before) the suspend process starts. FIG. 5B illustrates data that is respectively stored in the non-volatile storage unit 211, the constant synchronization area 261 and the secondary storage device 203 when (before) the suspend process ends.

Pages 1 to 3 are stored in the non-volatile storage unit 211. This state is kept before and after the suspend process. When the suspend process starts, pages 4 to 7 are stored in the constant synchronization area 261 of the volatile storage unit 212. The pages 4 to 7 are also stored in the secondary storage device 203. This is because, in a state in which the pages 4 to 7 are stored in the constant synchronization area 261, as a result of synchronization with the storage state of the constant synchronization area 261, the pages 4 to 7 are also stored in the secondary storage device 203.

The secondary storage device 203 is usually synchronized with the constant synchronization area 261 when the information processing apparatus 200 is activated. When the information processing apparatus 200 is activated, the pages are being stored in the volatile storage unit 212. While such a volatile storage unit 212 is being operated, the secondary storage device 203 is usually synchronized with the constant synchronization area 261.

In addition the synchronized page (data) is a page that is necessarily saved in the secondary storage device 203 during the suspend process.

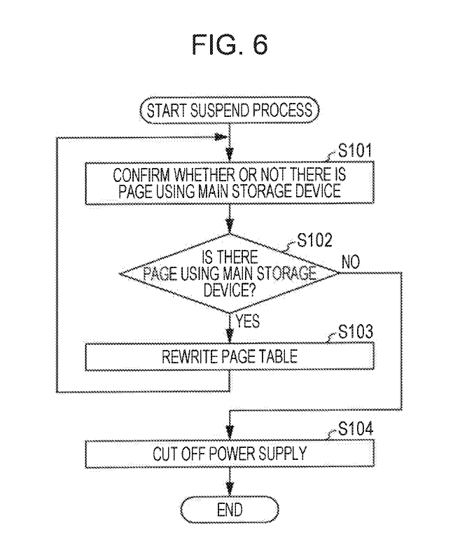

When the suspend process starts, the data of the page to be copied from the constant synchronization area 261 (volatile storage unit 212) to the secondary storage device 203 has been already copied. Thus, it is possible to eliminate time to copy the data from the volatile storage unit 212 to the secondary storage device 203 during the suspend process. That is, time for the suspend process can be shortened. With regard to this, a description will be made with reference to a flow chart in FIG. 6.

### Suspend Process in First Embodiment

The process of the flow chart in FIG. 6 starts when an instruction to start a suspend process is given to each unit of the information processing apparatus 200 from the suspend instruction unit 251 by giving the instruction to start the suspend process by a user.

In Step S101, the page table management unit 252 confirms the managed page table to confirm whether there is a virtual page using the volatile storage unit 212.

In Step S102, it is determined whether there is a virtual page using the volatile storage unit 212 by using a result of the confirmation of the table management unit 252. In Step S102, if it is determined that there is a virtual page using the volatile storage unit 212, the process proceeds to Step S103.

In Step S103, a process of invalidating a virtual address mapping the virtual page that is determined as a virtual page using the volatile storage unit 212 is performed. That is, the page table management unit 252 updates the page table and invalidates the virtual address mapping the saved page.

Further, the physical memory allocation management unit 253 releases the saved page and forms an empty area. Then, the process returns to Step S101, and the subsequent processes are repeated.

On the other hand, in Step S102, if it is determined that there is no virtual page using the volatile storage unit 212, the process proceeds to Step S104. In Step S104, the power of the information processing apparatus 200 is cut off and the suspend process ends.

Here, the suspend process in the related art illustrated in FIG. 2 is compared with the suspend process in the present technology illustrated in FIG. 6. According to the suspend process of the related art illustrated in FIG. 2, the process of securing an empty capacity of the secondary storage device 103 in Step S13, and the process of copying the page from the main storage device 102 to the secondary storage device 103 in Step S14 are included.

According to the suspend process according to the present technology illustrated in FIG. 6, processes corresponding to the processes executed in Step S13 and Step S14 are not performed. That is, processes corresponding to the processes executed in Step S12 and Step S13 can be omitted.

A process executed in Step S14 is a process which takes time since writing to the secondary storage device 203 is performed at a low access rate. Since this time-taking process can be omitted according to the embodiment that has been described with reference to FIGS. 4 to 6, it is possible to end the suspend process in s short period of time.

### Configuration of Information Processing Apparatus According to Second Embodiment

In the first embodiment, it has been described that the data stored in the volatile storage unit 212 is synchronized with the data stored in the secondary storage device 203 by copying the data stored in the volatile storage unit 212 of the main storage device 202 to the secondary storage device 203 so as to shorten time for the suspend process.

However, if the process of copying the data stored in the volatile storage unit 212 to the secondary storage device 203 is frequently performed during the operation of the information processing apparatus 200, or the amount of data to be copied is large, the execution rate of the information processing apparatus 200 may be decreased. For example, there is a possibility that the processing rate of the activated application may be than the processing rate of the process of copying the data from the volatile storage unit 212 to the secondary storage device 203. It is preferable that such lowering of the processing rate do not occur.

In addition, if the secondary storage device 203 is configured by, for example, a NAND flash memory, the rewriting life of the NAND flash memory may be shortened. Since the NAND flash memory is deteriorated by electrons penetrating an oxide film which is an insulating body in operation principle, deletable and writable times are limited. Therefore, for example, the secondary storage device 203 that is configured by the NAND flash memory has a shorter rewriting life than the secondary storage device 203 that is configured by a hard disk or the like. In consideration of these situations, it is preferable that the number of rewriting to the secondary storage device 203 be small. It is suitable that the number of data copy from the volatile storage unit 212 to the secondary storage device 203 is small.

In consideration of these situations, a second embodiment in which the number of rewriting to the secondary storage device 203 is small, that is, a total amount of data to be copied from the volatile storage unit 212 to the secondary storage device 203 is small will be described.

In the second embodiment which will be described later, pages are exchanged between the non-volatile storage unit 211 and the volatile storage unit 212, and a page of which the number of rewriting is likely to increase is controlled to be collected in the non-volatile storage unit 211.

In addition, as in the first embodiment, the pages stored in the volatile storage unit 212 are synchronized with the pages stored in the secondary storage device 203. However, in the second embodiment, since the page stored in the volatile storage unit 212 is a page that has relatively a small number of rewriting and has a low possibility of being rewritten, the number of writing to the secondary storage device 203 itself can be reduced.

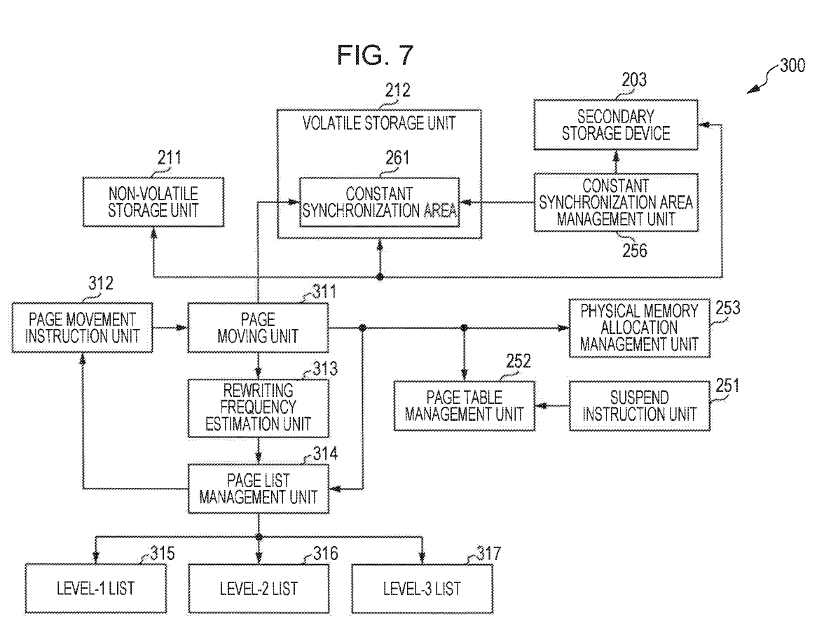

FIG. 7 is a diagram illustrating a configuration of an information processing apparatus 300 according to the second embodiment. The same numeral references will be attached to portions having the same functions as in the information processing apparatus 200 illustrated in FIG. 4 and the description thereof will be omitted.

The information processing apparatus 300 illustrated in FIG. 7 includes the secondary storage device 203, the non-volatile storage unit 211, the volatile storage unit 212, the suspend instruction unit 251, the page table management unit 252, the physical memory allocation management unit 253, the constant synchronization area 261, a page moving unit 311, a page movement instruction unit 312, a rewriting frequency estimation unit 313, a page list management unit 314, a level-1 list 315, a level-2 list 316, and a level-3 list 317.

The secondary storage device 203, the non-volatile storage unit 211, the volatile storage unit 212, the suspend instruction unit 251, the page table management unit 252, the physical memory allocation management unit 253, and the constant synchronization area 261 in the information processing apparatus 300 are the same as those in the information processing apparatus 200 illustrated in FIG. 4.

The page moving unit 311 and the page movement instruction unit 312 in the information processing apparatus 300 are basically the same as the page moving unit 254 and the page movement instruction unit 255 in the information processing apparatus 200 illustrated in FIG. 4, but a portion to be referred, a portion which gives an instruction, and the like are different.

The rewriting frequency estimation unit 313, the page list management unit 314, the level-1 list 315, the level-2 list 316, and the level-3 list 317 in the information processing apparatus 300 are added to the configuration of the information processing apparatus 200 illustrated in FIG. 4.

The page moving unit 311 moves the page obtained from the rewriting frequency estimation unit 313 to any one of the non-volatile storage unit 211 and the volatile storage unit 212 (constant synchronization area 261) according to rewriting frequency of the page.

If it is estimated that the rewriting frequency of the page is high, the page is moved to the non-volatile storage unit 211. If it is estimated that the rewriting frequency of the page is approximately middle, the page is moved to the constant synchronization area 261 in the volatile storage unit 212. If it is estimated that the rewriting frequency of the page is low, the data of the page is not physically moved. The page moving unit 311 moves the page based on these instructions from the page movement instruction unit 312 and notifies the movement destination to the page list management unit 314 during the page movement.

The page movement instruction unit 312 gives an instruction to the page moving unit 311 to move the page in response to the request from the page list management unit 314.

The rewriting frequency estimation unit 313 estimates rewriting frequency of the designated page. The rewriting frequency is determined based on which list the page is logically moved to among the level-1 list 315, the level-2 list 316, and the level-3 list 317.

The level-1 list 315, the level-2 list 316, or the level-3 list 317 is a list for managing pages at every rewriting frequency as described later. Here, the level-1 list 315, the level-2 list 316, and the level-3 list 317 are lists for managing pages having a high rewriting frequency in order.

When a page as a processing target is moved to the level-1 list 315, the rewriting frequency estimation unit 313 estimates that the page has a high rewriting frequency. When the page is moved to the level-2 list 316, the rewriting frequency estimation unit 313 estimates that the page has a middle rewriting frequency. When the page is moved to the level-3 list 317, the rewriting frequency estimation unit 313 estimates that the page has a low rewriting frequency.

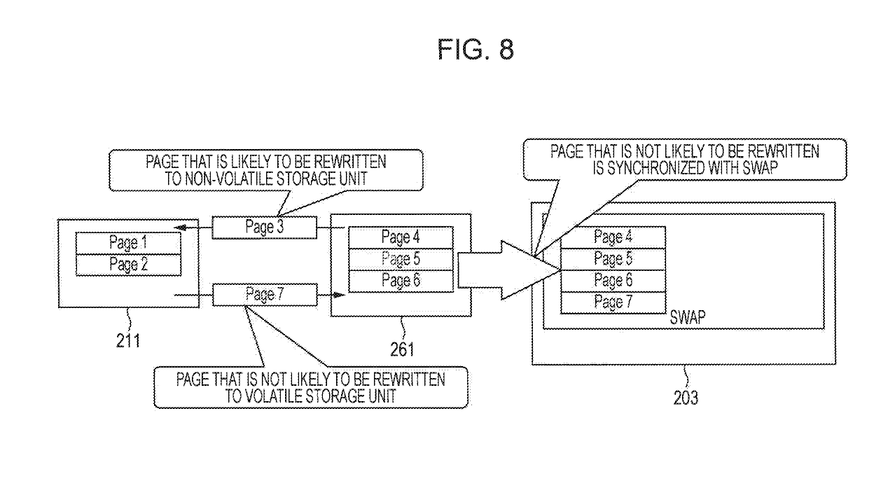

The list which becomes a movement destination of the page is determined based on which level list the page belongs to and what operation causes a page movement request. A specific description will be made later with reference to FIGS. 8 to 10.

The page list management unit 314 is a logical list for managing the pages at every rewriting frequency and operates the level-1 list 315 and the level-3 list 317 here. In entry elements registered in these lists, an access request to a page in which a pointer of a physical page is included is monitored and the entry order in the lists is changed depending on the type of the access or an entry is added or deleted.

If the data stored in the page is physically moved by the page moving unit 311, an entry indicating the movement source page is deleted from the list in which the entry is written and an entry indicating the movement destination page is additionally written to the list corresponding to the movement destination. That is, an entry indicating predetermined data is logically moved between the lists. The logical page movement will be described later with reference to FIGS. 8 to 10.

The level-1 list 315 is a list for managing pages which is estimated to have a high rewriting frequency. The list is managed in means of the least-recently-used (LRU) method and is managed such that a page most recently written is listed later in logical order. All pages managed in the level-1 list 315 are arranged in the non-volatile storage unit 211. Accordingly, the size of the level-1 list 315 is set to be equal to or smaller than the number of pages that can be stored in the non-volatile storage unit 211.

The level-2 list 316 is a list for managing pages which is estimated to have a middle rewriting frequency. The level-2 list 316 is also managed in means of the least-recently-used (LRU) method and is managed such that the page most recently written is listed later in logical order among the pages estimated to have a middle rewriting frequency. All pages managed in the level-2 list 316 are arranged in the constant synchronization area 261 of the volatile storage unit 212.

Accordingly, the size of the level-2 list 316 is set to be equal to or smaller than the number of pages that can be stored in the constant synchronization area 261. Further, since the contents of the pages managed in the level-2 list 316 are stored in the secondary storage device 203 by the constant synchronization area management unit 256, the data of the pages is held in both the main storage device 202 and the secondary storage device 203.

The level-3 list 317 is a list for managing pages which is estimated to have a low rewriting frequency. The level-3 list 317 is not necessarily managed in means of the least-recently-used (LRU) method. All pages managed in the level-3 list 317 are pages saved in the secondary storage device 203 and are not present in the main storage device 202. Therefore, the entry of the level-3 list holds a pointer to a predetermined area of the secondary storage device 203 which saves a predetermined page of the main storage device 202. The size of the level-3 list 317 is set to be equal to or smaller than the number of pages that can be stored in the secondary storage device 203.

### Page Movement and List Update in Second Embodiment

With reference to FIG. 8, the page movement will be described. In the non-volatile storage unit 211, pages 1 and 2 are stored. The pages 1 and 2 are respectively pages estimated to have a high rewriting frequency of the data managed in the respective pages. Pages 4, 5 and 6 are stored in the constant synchronization area 261 of the volatile storage unit 212. The pages 4, 5 and 6 are respectively pages estimated to have a middle rewriting frequency of the data managed in the respective pages.

For example, the page 3 is stored in the constant synchronization area 261. If the data managed in the page 3 is rewritten in this state, the estimation regarding the page 3 is changed such that the rewriting frequency is not middle but high. In this case, the page 3 that is stored in the constant synchronization area 261 is moved to the non-volatile storage unit 211 as a page which is likely to be rewritten.

In addition, for example, a page 7 is stored in the non-volatile storage unit 211. However, the estimation regarding the page 7 is changed such that the rewriting frequency is not high but middle. In this case, the page 7 stored in the non-volatile storage unit 211 is moved to the constant synchronization area 261 as a page which is not likely to be rewritten.

Since the constant synchronization area 261 and the secondary storage device 203 are synchronized with each other, the pages 4, 5, 6, and 7 are also stored in the secondary storage device 203. The page 7 is moved to the constant synchronization area 261 from the non-volatile storage unit 211, and then, copied to the secondary storage device 203. When the pages 4 to 7 are rewritten, the pages synchronized with the secondary storage device 203 to be stored are also necessarily rewritten. However, the pages 4 to 7 respectively have a middle rewriting frequency, and thus, the number of rewriting itself is small and the number of writing to the secondary storage device 203 can be small.

As described above, the pages stored in the non-volatile storage unit 211 are managed in the level-1 list 315, and the pages synchronized with the constant synchronization area 261 and the secondary storage device 203 to be stored are managed in the level-2 list 316. According to such management, the pages can be managed as long as there are the level-1 list 315 and the level-2 list 316. Further, in the embodiment, the level-3 list 317 is provided and thus, the pages are also managed using the level-3 list 317.

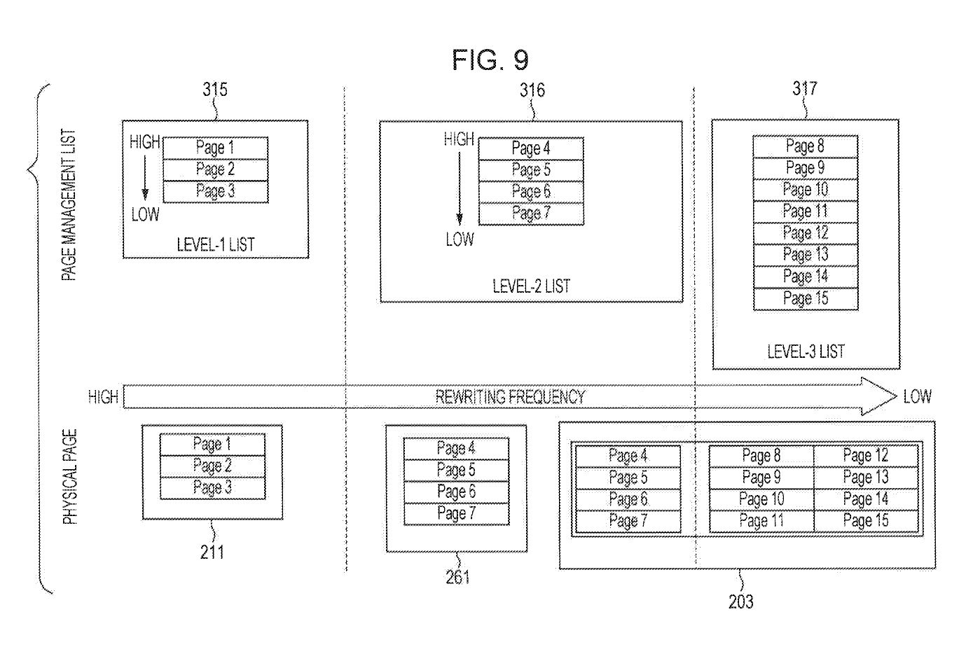

A relationship between the pages stored in the storage unit and the lists will be described with reference to FIG. 9. In the state illustrated in FIG. 9, the pages 1 to 3 are stored in the non-volatile storage unit 211. At this time, information on the pages 1 to 3 is written in the level-1 list 315 for managing the pages stored in the non-volatile storage unit 211.

Since the level-1 list 315 is a LUR type list, the page which is listed later in logical order is a page which is most recently rewritten and is likely to be rewritten. In FIG. 9, the upward direction is set for the page which is listed later in logical order in an upward direction and the page which has a high possibility of being written is illustrated.

In addition, in the state illustrated in FIG. 9, the pages 4 to 7 are stored in the constant synchronization area 261 of the volatile storage unit 212. Since the pages stored in the constant synchronization area 261 are also stored in the swap area in the secondary storage device 203, as illustrated in FIG. 9, the pages 4 to 7 are also stored in the secondary storage device 203.

In the level-2 list 316 for managing the constant synchronization area 261 and an area synchronized with the constant synchronization area 261 in the secondary storage device 203, information on the pages 4 to 7 is written. Since the level-2 list 316 is a LUR type list, the page which is listed later in logical order is a page which is likely to be rewritten in the level-2 list 316.

In the swap area in the secondary storage device 203, pages 8 to 15 are also stored. The pages 8 to 15 are pages that have to be saved during suspend execution. However, the pages are estimated as pages having a low rewriting frequency. The pages only stored in the secondary storage device 203 are managed in the level-3 list 317. Accordingly, information on the pages 8 to 15 is rewritten in the level-3 list 317. The level-3 list 317 is not a LUR type list.

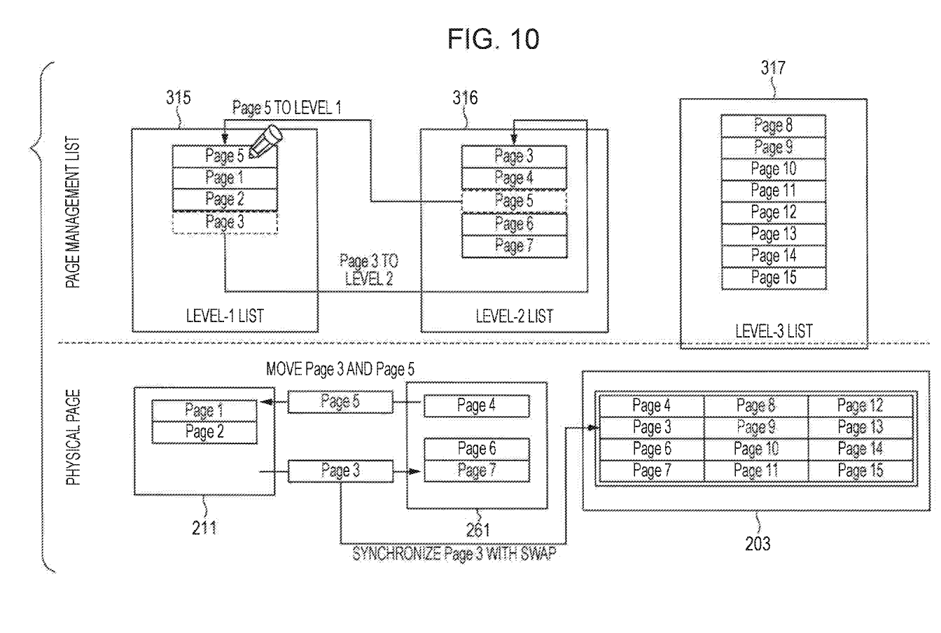

In such a state, a process when the data of a predetermined page is rewritten will be described with reference to FIG. 10.

The pages stored respectively in the non-volatile storage unit 211, the constant synchronization area 261, and the secondary storage device 203 are in the same state illustrated in FIG. 9 and in such a state, the page 5 is rewritten. The page 5 is stored in the constant synchronization area 261 and managed in the level-2 list 316.

Since the page 5 is rewritten, the page 5 is a page which is most recently rewritten and is set as a page which is likely to be rewritten. Therefore, the management of the page 5 is changed from by the level-2 list 316 to by the level-1 list 315.

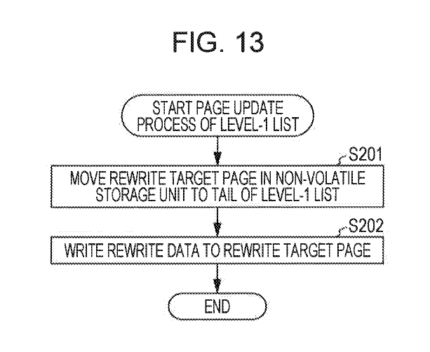

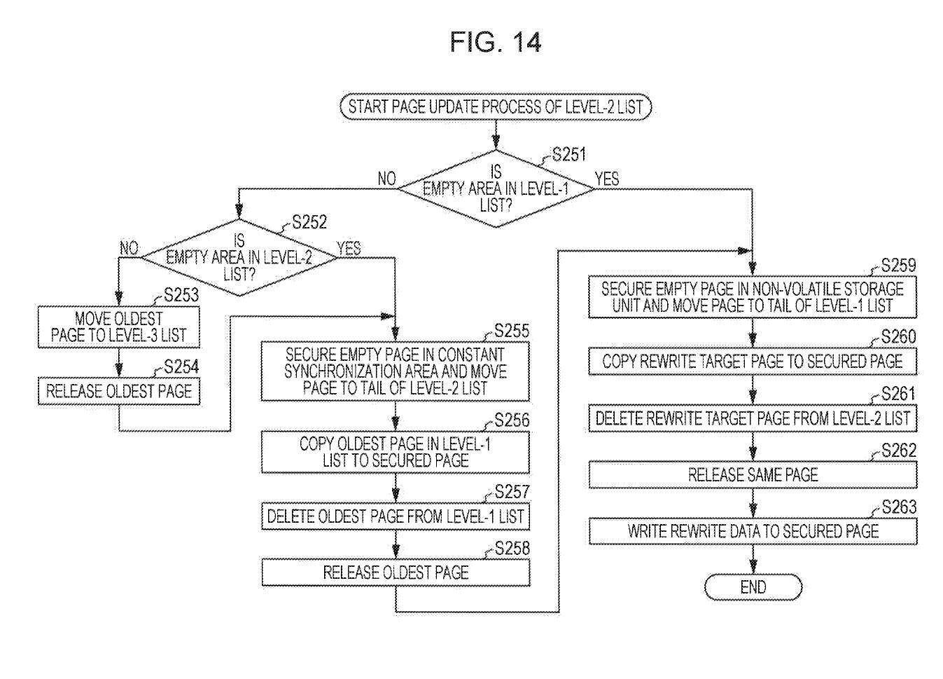

The page 5 itself moves from the constant, synchronization area 261 to the non-volatile storage unit 211. At this time, the page 3 is moved to the constant synchronization area 261 from the non-volatile storage unit 211 to empty a capacity for storing the page 5. Such a process will be described in detail later with reference to flow charts in FIGS. 13 and 14.

The level-1 list 315 and the level-2 list 316 are respectively rewritten by moving the pages. Information on the page 5 is added to the level-1 list 315 later in logical order (in the drawing, the highest position). In addition, information on the page 3 is deleted from the level-1 list 315. Since the page 3 is most recently written (in the drawing, the lowest position) in the logical order of the level-1 list 315, the page is set as a target to be moved from the non-volatile storage unit 211 to the constant synchronization area 261 and is moved.

The level-2 list 316 is rewritten to delete the information on the page 5 and the information on the page 3 is added. The information on the page 3 is added to the level-2 list 316 later in the logical order (in the drawing, the highest position).

The page 3 is written to the constant synchronization area 261 and the secondary storage device 203 by adding the information on the page 3 to the level-2 list 316. That is, the page 3 is synchronized between the constant synchronization area 261 and the secondary storage device 203.

As described above, the page movement and the rewriting to the lists associated with the page movement are performed.

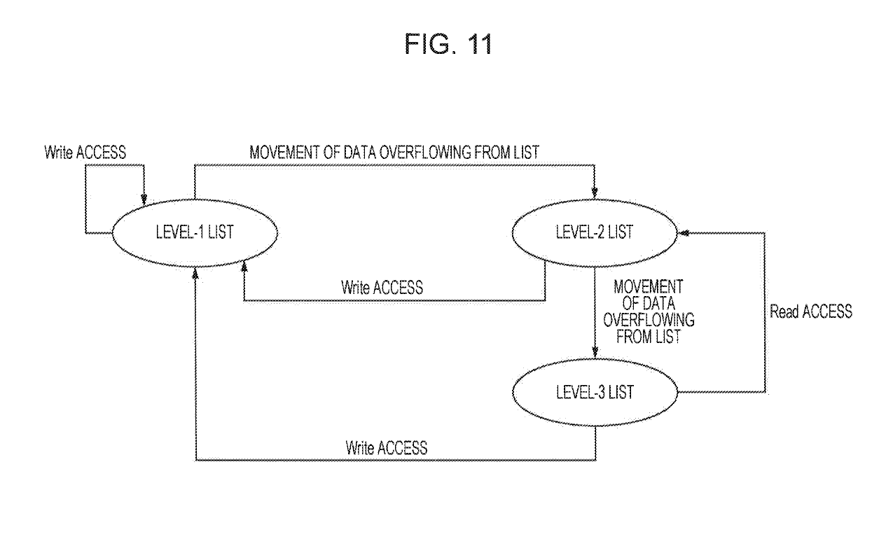

The description of the page movement and the rewriting to the lists associated with the page movement will be further added with reference to FIG. 11. When rewriting (Write access) is performed on the pages managed in the level-1 list 315, the information on the rewritten page is moved later in the logical order in some cases. However, a process of moving the information on the page to another list is not performed. In addition, a process of moving the rewritten page to another storage unit is not performed and the page maintains a state in which the page is stored in the non-volatile storage unit 211.

When level-1 list 315 is full, the information on pages that is not able to be stored in the level-1 list 315, that is, the information on pages that may not stored because of the capacity of the non-volatile storage unit 211 is moved to the level-2 list 316. For example, by adding information on a new page to the level-1 list 315, information on the page, which is not able to be stored in level-1 list 315 and is listed at the highest position in the logical order of the list (the rewritten page is the oldest page among the pages managed in the level-1 list 315), is moved to the tail end of the level-2 list 316 in logical order.

When rewriting (Write access) is performed on the pages managed in the level-2 list 316, the information on the rewritten pages is moved to the tail end of the level-1 list 315 in logical order. In addition, the written pages are moved from the constant synchronization area 261 to the non-volatile storage unit 211.

When rewriting (Write access) is performed on the pages managed in the level-3 list 317 in the same manner, the information on the rewritten pages is moved to the tail end of the level-1 list 315 in logical order. Further, the rewritten page is moved to from the secondary storage device 203 to the non-volatile storage unit 211.

When the level-2 list 316 is full, the information on the page, which is listed at the head of the level-2 list 316 in logical order (the rewritten page is the oldest page among the pages managed in the level-2 list 316), is moved to the level-3 list 317. Since the level-3 list 317 is not a LRU type list, it is not necessary to consider the order of the movement destination.

When a read (Read) access is performed on the pages managed in the level-1 list 315 or the level-2 list 316, a page movement or a process of rewriting the list is not performed. Contrarily, when a read access is performed on the pages managed in the level-3 list 317, the information on the pages is moved to the level-2 list 316 and the pages are moved from the secondary storage device 203 to the volatile storage unit 212 (constant synchronization area 261).

This is because the pages managed in the level-3 list 317 are present in the secondary storage device 203 and not present in the main storage device 202. If reading is performed from the secondary storage device 203 to the main storage device 202, an access is not possible.

In this manner, when the pages are rewritten, the pages are moved to the level 1 and sequentially moved to the levels 2 and 3 as the reading is not performed. Since there is locality in a typical memory access, it can be expected that the pages are arranged to the level 1, the level 2 and the level 3 sequentially from the memory estimated that rewriting frequency is high from this point on among the pages.

As described above, in the embodiment, the pages are sorted to any one of the level-1 list 315, the level-2 list 316 and the level-3 list 317 according to the rewriting frequency and managed in the list of the sorting destination.

In addition, in the embodiment, the rewriting frequency of the page is determined by the rewriting frequency estimation unit 313 (FIG. 7) based on which level list, the pages moved to. Further, the page to be logically moved to the level 1 is physically moved to the non-volatile storage unit 211, and the page to be moved to the level 2 is physically moved to the constant synchronization area 261, respectively, by combining with the page moving unit 311 (FIG. 7).

That is, if the rewriting frequency is high, the page is moved to the non-volatile storage unit 211. While the page is frequently rewritten, the page stays in the non-volatile storage unit 211. When the rewriting frequency is reduced and the page is moved from the level 1 to the level 2, the data is moved to the constant synchronization, area 261 to be synchronized with the secondary storage device 203.

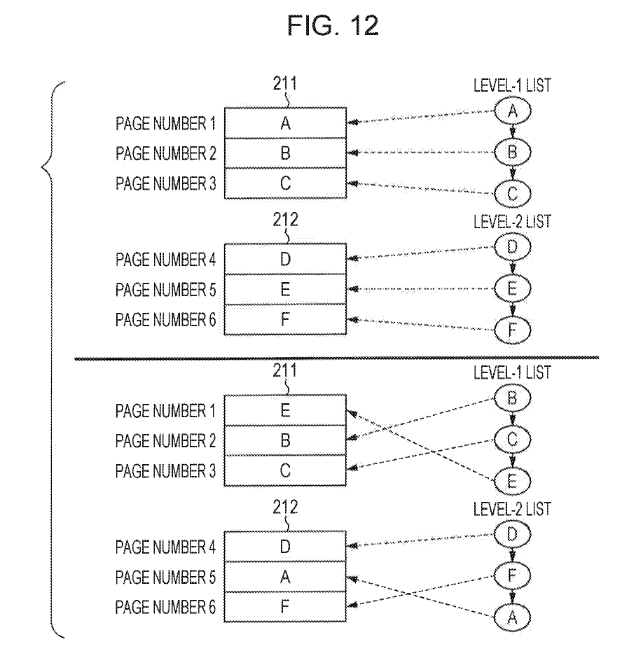

How the physical data arrangement and the logical list structure change during the page movement will be described with reference to FIG. 12.

In the example illustrated in FIG. 12, the page holding data E is moved based on logic from the level 2 to the level 1, and the page holding data A is logically moved from the level 1 to the level 2. Before the movement, the data E is held in a page number 5. The entry indicating the page holding the data B belongs to the level-2 list 316 and points out the page number 5.

After the movement, the data B is held in a page number 1. The entry indicating the page holding the data E belongs to the level-1 list 315 and the pointed page number is changed to 1 from 5 before the movement.

In the same manner, the data A is held in the page number 1 before the movement. The entry indicating the page holding the data A belongs to the level-1 list 315 and points out the page number 1. After the movement, the data A is held in the page number 5. The entry indicating the page holding the data A belongs to the level-2 list 316 and the pointed page number is changed to 5 from 1 before the movement.

Further, an operation when the page is logically and physically moved will be described with reference to FIGS. 13 and 14. First, the operation when the page is logically and physically moved will be described with reference to the flow chart in FIG. 13 by using a case in which a predetermined application program tries to rewrite the page of the level 1 as an example.

When the pages managed in the level-1 list 315, that is, the pages stored in the non-volatile storage unit 211 are rewritten, the information in the level-1 list 315 corresponding to the rewritten page is moved to the tail in logical order in Step S201.

In Step S202, the rewritten data is written to a rewriting target page to end the process.

Next, the operation when the page is logically and physically moved will be described with reference to the flow chat in FIG. 14 by using a case in which a predetermined application program tries to rewrite the page of the level 2 as an example.

When the pages managed in the level-2 list 316, that is, the pages stored in the constant synchronization area 261 and a predetermined area that is synchronized with the constant synchronization area 261 in the secondary storage device 203 are rewritten, the page list management unit 314 (FIG. 7) determined whether there is an empty area in the level-1 list 315 which is a movement destination in Step S251.

When the page list management unit 314 determines that there is no empty area in the level-1 list 315 in Step S251, the process proceeds to Step S252. In Step S252, it is determined where there is an empty area in the level-2 list 316. In this case, it is necessary to form an empty area in the level-1 list 315 by moving the page from the level-1 list 315 to the level-2 list 316. The page list management unit 314 confirms whether there is an empty area in the level-2 list 316 of the movement destination.

If it is determined that there is no empty area in Step S252, the process proceeds to Step S253. In Step S253, a process of forming an empty area in the level-2 list 316 by moving the page from the level-2 list 316 to the level-3 list 317 is performed.

The page list management unit 314 requests the page movement instruction unit 312 to move the page which is at the head of the level-2 list 316 in logical, order and has the oldest rewriting time. The page movement instruction unit 312 gives an instruction for the requested page movement to the page moving unit 311.

The page moving unit 311 inquires the rewriting frequency of the page to which the movement instruction is given of the rewriting frequency estimation unit 313. The rewriting frequency estimation unit 313 confirms that the movement target is the page in the level-2 list 316 and the movement instruction is given when the level-2 list 316 is full, and notifies the page moving unit 311 of the rewriting frequency being low.

The page moving unit 311 notifies the page list management unit 314 of completing the movement without copying the data of the movement target page. In this case, since the page stored in the constant synchronization area 261 is already synchronized with the secondary storage device 203 to be stored therein, a process such as a physical page movement or the like is not necessarily executed. Therefore, the page moving unit notifies the page list management unit 314 of completing the movement without copying the data of the movement target page.

The page list management unit 314 deletes the entry indicating the movement target page from the level-2 list 316 and the entry indicating an area of the secondary storage device 203 which is synchronized with the data of the movement target page is added to the level-3 list 317.

In Step S254, the page moving unit 311 notifies the page table management unit 252 and the physical memory allocation management unit 253 of moving the movement target page from the constant synchronization area 261 to the secondary storage device 203. The page table management unit 252 invalidates an access to the virtual address mapping the movement target page and records information for determining where the data in the address is moved in the secondary storage device 203. Simultaneously, the physical memory allocation management unit 253 records the movement target page as an empty area

If the oldest page is released in Step S254, the process proceeds to Step S255. The process also proceeds to Step S255 when it is determined that there is an empty area in the level-2 list 316 in Step S252. In Step S255, the page list management unit 314 requests the page movement instruction unit 312 to move the page which is at the head of the level-1 list 315 and has the oldest rewriting time.

The page movement instruction unit 312 gives an instruction for the requested page movement to the page moving unit 311. The page moving unit 311 inquires the rewriting frequency of the page to which the movement instruction is given of the rewriting frequency estimation unit 313. The rewriting frequency estimation unit 313 confirms that the movement target is the page managed in the level-1 list 315 and the movement instruction is given when the level-1 list 315 is full, and notifies the page moving unit 311 of the rewriting frequency being middle.

The page moving unit 311 requests the physical memory allocation management unit 253 to allocate the constant synchronization area 261 to secure a movement destination. The physical memory allocation management unit 253 notifies the page moving unit 311 of selecting one page from an empty area in the constant synchronization area 261 to be in use. The page moving unit 311 requests the page list management unit 314 to register the secured movement destination page to the level-2 list 316. The page list management unit 314 registers the movement destination page to the tail of the level-2 list 316 as the most recently rewritten page.

In Step S256, the page moving unit 311 copies the movement target page to the secured movement destination page. The constant synchronization area management unit 256 detects rewriting of the data of the constant synchronization area 261 and copies the data of the page to a predetermined area of the secondary storage device 203.

In Step S257, the page moving unit 311 notifies the page list management unit 314 of completing the page movement. The page list management unit 314 deletes the movement, target page from the level-1 list 315.

In Step S258, the page moving unit 311 notifies the page table management unit 252 and the physical memory allocation management unit 253 of moving the movement target page from the non-volatile storage unit 211 to the constant synchronization area 261. The page table management unit 252 changes the virtual address mapping the movement target page to map the movement destination page. The physical memory allocation management unit 253 releases the movement target page to set the page as an empty area

On the other hand, when it is determined that there is an empty area in the level-1 list 315 in Step S251, or when an empty area is formed in the level-1 list 315 by ending the process in Step S258, the process proceeds to Step S259.

In Step S259, when there is an empty area in the level-1 list 315, the page management unit 314 requests the page movement instruction unit 312 to move the rewritten page. The page movement instruction unit 312 gives an instruction for the requested page movement, to the page list moving unit 311. The page moving unit 311 inquires the rewriting frequency of the page to which the movement, instruction is given of the rewriting frequency estimation unit 313.

The rewriting frequency estimation unit 313 confirms that the movement instruction is given when the page is rewritten and notifies the page moving unit 311 of the rewriting frequency being high. The page moving unit 311 requests the physical memory allocation management unit 253 to allocate the non-volatile storage unit 211 to secure a movement destination.

The physical memory allocation management unit 253 notifies the page moving unit 311 of selecting one page from an empty area in the non-volatile storage unit 211 to be in use. The page moving unit 311 requests the page list management unit 314 to register the secured movement destination page to the level-1 list 315. The page list management unit 314 registers the movement destination page to the tail of the level-1 list 315 as the most recently rewritten page.

In Step S260, the page moving unit 311 copies the rewriting target page to the secured movement destination page. In Step S261, the page moving unit 311 notifies the page list management unit 314 of completing the page movement. The page list management unit 314 deletes the information on the movement target page from the level-2 list 316.

In Step S262, the page moving unit 311 notifies the page table management unit 252 and the physical memory allocation management unit 253 of moving the movement target page from the constant synchronization area 261 to the non-volatile storage unit 211.

The page table management unit 252 changes the virtual address mapping the movement target page to map the movement destination page. The physical memory allocation management unit 253 releases the movement target page to set an empty area. In Step S263, the application program writes data to the movement destination page.

In this manner, when the pages managed in the level-2 list 316 are rewritten, the pages stored in the constant synchronization area 261 are moved so that the pages are stored in the non-volatile storage unit 211.

When the pages managed in the level-3 list 317 are rewritten, the flow of the basic processes is the same as in the case in which the pages managed in the level-2 list 316 illustrated in FIG. 14 are rewritten. Thus, the description thereof will be omitted.

Further, the suspend process can be performed based on the flow chart illustrated in FIG. 6. Also in the second embodiment, as in the first embodiment, the pages that are stored in the volatile storage unit 212 are already stored in the secondary storage device 203 at the time point when the suspend process starts, and thus, a process of copying (saving) the pages can be omitted. Therefore, also in the second embodiment, it is possible to shorten time for the suspend process.

### Configuration of Information Processing Apparatus According to Third Embodiment

Next, a configuration and a suspend process of an information processing apparatus according to the third embodiment will be described. Generally, the non-volatile storage unit 211 configured by, for example, an NVRAM has a shorter rewriting life and asks more power for rewriting than that of the volatile storage unit 212 configured by, for example, a DRAM. In the third embodiment, an embodiment suitable for such a situation will be described.

According to the second embodiment, the data (pages) that is most frequently rewritten at a certain time point is (are) concentrated in the non-volatile storage unit 211. As a result, the number of rewriting to the non-volatile storage unit 211 is larger than the number of rewriting to the volatile storage unit 212. Accordingly, for the above reason, the rewriting life of the non-volatile storage unit 211 may be affected.

In addition, since the number of rewriting to the non-volatile storage unit 211 is larger than the number of rewriting to the volatile storage unit 212, the number of rewriting to the non-volatile storage unit 211 which asks for a large amount of power for the rewriting is increased. Thus, power consumption may be increased.

Here, in the third embodiment, the information processing apparatus capable of reducing the rewriting frequency to the non-volatile storage unit 211 and as in the above-described embodiment, shortening time for a suspend process will be described.

In the information processing apparatus according to the third embodiment, the pages having a high rewriting frequency that are concentrated in the volatile storage unit 212 are prepared to be saved in a short period of time during suspend execution by concentrating the pages which are likely to have the highest rewriting frequency in the volatile storage unit 212. Further, the pages having a low rewriting frequency are synchronized between the volatile storage unit and the secondary storage device as in the above-described embodiment.

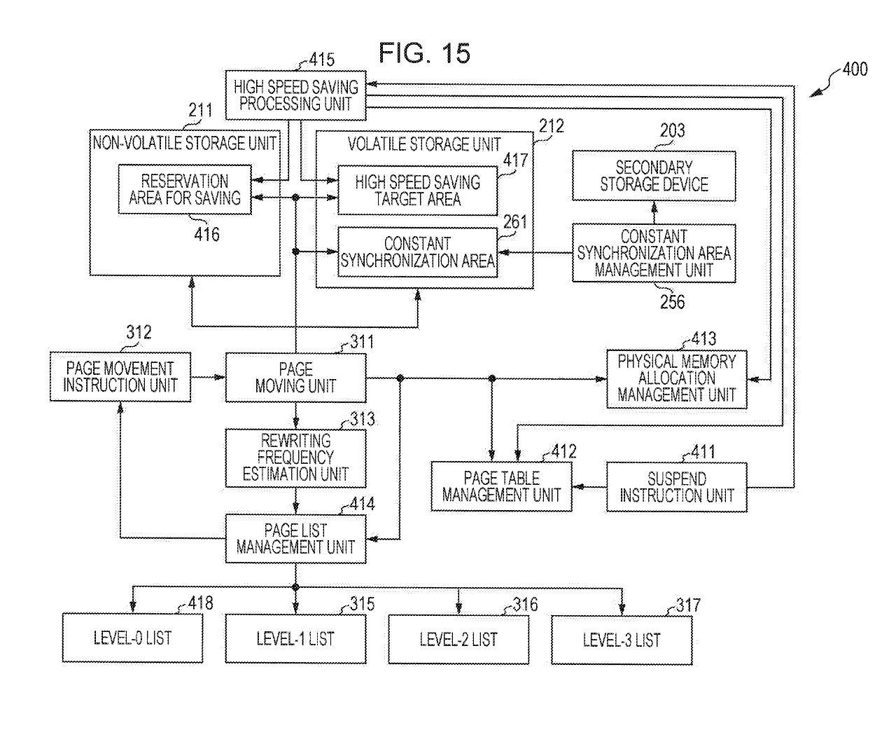

FIG. 15 is a diagram illustrating the configuration of the information processing apparatus 400 according to the third embodiment. The same references are given to components having similar functions to those of the information processing apparatus 300 illustrated in FIG. 7, and the description thereof will be omitted.

The information processing apparatus 400 illustrated in FIG. 15 includes the secondary storage device 203, the non-volatile storage unit 211, the volatile storage unit 212, the constant synchronization area 261, the page moving unit 311, the page movement instruction unit 312, the rewriting frequency estimation unit 313, the level-1 list 315, the level-2 list 316, and the level-3 list 317 as in the information processing apparatus 300 illustrated in FIG. 7. Each of these units is the same as each of the corresponding units of the information processing apparatus 300 illustrated in FIG. 7.

The information processing apparatus 400 also includes a suspend instruction unit 411, a page table management unit 412, a physical memory allocation management unit 413, and a page list management unit 414. Each of these units is the same as each of the corresponding units of the information processing apparatus 300 illustrated in FIG. 7, but a portion to be referred, a portion which gives an instruction, and the like are different.

A high speed saving processing unit 415, a reservation area for saving 415, a high speed saving target area 417, and a level-0 list 418 of the information processing apparatus 400 are portions which are added to the configuration of the information processing apparatus 300 illustrated in FIG. 7.

The high speed saving processing unit 415 has a function of saving the data in the high speed saving target area 417 in the reservation area for saving 416 when the suspend process is executed. The reservation area for saving 416 is provided in the non-volatile storage unit 211, and the high speed saving target area 417 is provided in the volatile storage unit 212. The pages stored in the high speed saving target area 417 are managed in the level-0 list 418.

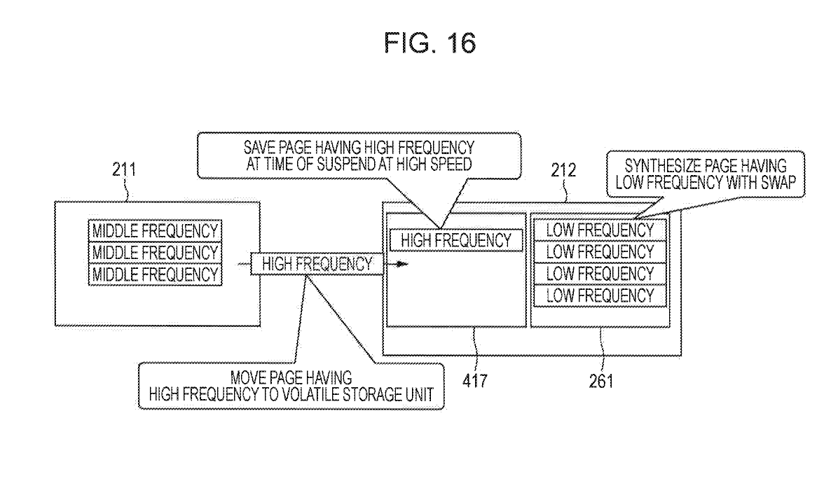

The pages having a higher rewriting frequency than the pages in the level-1 list 315 are managed in the level-0 list 418. Physically, the pages included in the level-0 list 418 are the pages stored in the high speed saving target area 417 of the volatile storage unit 212. That is, as illustrated in FIG. 16, a group of the pages having the highest rewriting frequency is placed in the volatile storage unit 212. Therefore, the concentration of the writing to the non-volatile storage unit 211 can be reduced, which contributes to a reduction in power consumption.

On the other hand, since the pages managed in the level-0 list 418 are stored in the high speed saving target area 417 of the volatile storage unit 212 as illustrated in FIG. 16, it is necessary to save the data during the suspend process in order to end the saving in a short period of time, the size of the high speed saving target area 417 is sufficiently reduced (the number of pages to be stored is reduced). Further, for the purpose of performing the saving at a high speed, the reservation area for saving 416 is secured in the nonvolatile storage unit 211 so that the data in the high speed saving target area 417 can be saved. Since the writing rate of the non-volatile storage unit 211 is higher than that of the secondary storage device 203, it is possible to end the saving in a short period of time.

The reservation area for saving 416 may be available immediately when the suspend process starts. The reservation area for saving may not be used during a normal operation, or the data in which saving is not necessary (for example, a file data cache or the like) may be placed in the reservation area for saving.

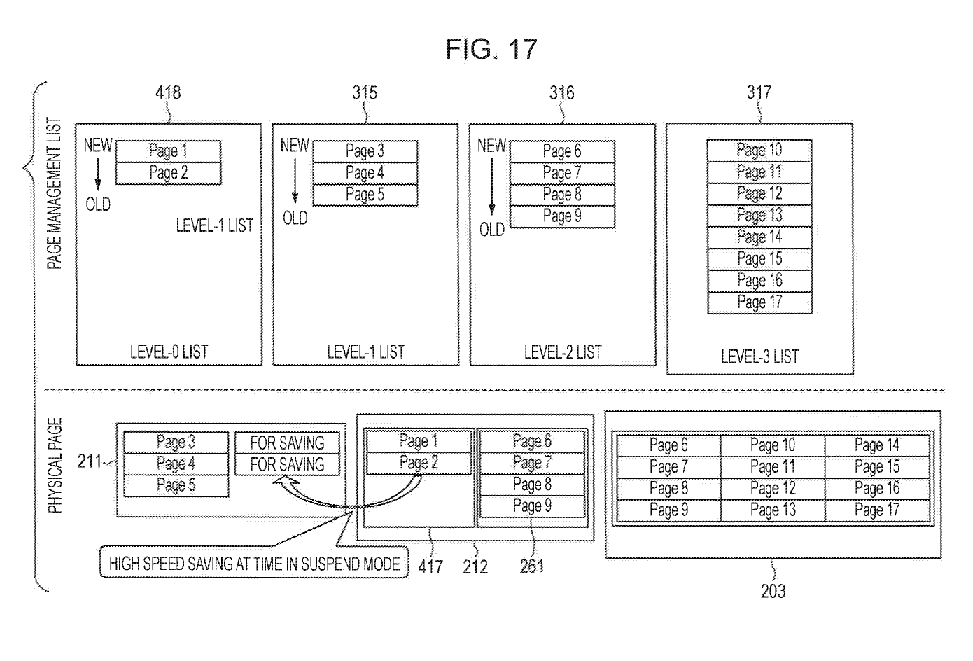

The relationship between the pages stored in the storage unit and the lists will be described with reference to FIG. 17. The state illustrated in FIG. 17 is a state in which pages 3 to 5 are stored in the non-volatile storage unit 211. At this time, the information on the pages 3 to 5 is written in the level-1 list 315 for managing the pages stored in the non-volatile storage unit 211.

The reservation area for saving 416 is provided in the non-volatile storage unit 211. The reservation area for saving 416 is an area to which the pages stored in the high speed saving target area 417 of the volatile storage unit 212 are moved during the suspend execution. In the state illustrated in FIG. 17, pages 1 and 2 are stored in the high speed saving target area 417. The pages 1 and 2 are saved in the reservation area for saving 416 of the non-volatile storage unit 211 when a suspend instruction is given.

In addition, the pages 1 and 2 are managed in the level-0 list 418. In this manner, the level-0 list 418 is a list for managing the pages stored in the high speed saving target area 417.

Further, the state illustrated in FIG. 17 is a state in which pages 6 to 9 are stored in the constant synchronization area 261 of the volatile storage unit 212. Since the pages stored in the constant synchronization area 261 are also stored in the swap area of the secondary storage device 203, as illustrated in FIG. 17, the pages 6 to 9 are also stored in the secondary storage device 203.

In the level-2 list 316 for managing constant synchronization area 261 and an area of the secondary storage device 203 which is synchronized with the constant synchronization area 261, the information on the pages 6 to 9 is written.

The level-0 list 418, the level-1 list 315 and the level-2 list 316 are LRU type lists. The page listed later in logical order in these lists is a page which is most likely to be rewritten in the lists.

In the swap area of the secondary storage device 203, pages 10 to 17 are stored. These pages 10 to 17 are pages which are necessarily saved during suspend execution, but are pages which are estimated to have a low rewriting frequency. The pages stored only in the secondary storage device 203 are managed in the level-3 list 317. Therefore, the information on the pages 10 to 17 is stored in the level-3 list 317. The level-3 list 317 is not necessarily a LRU type list.

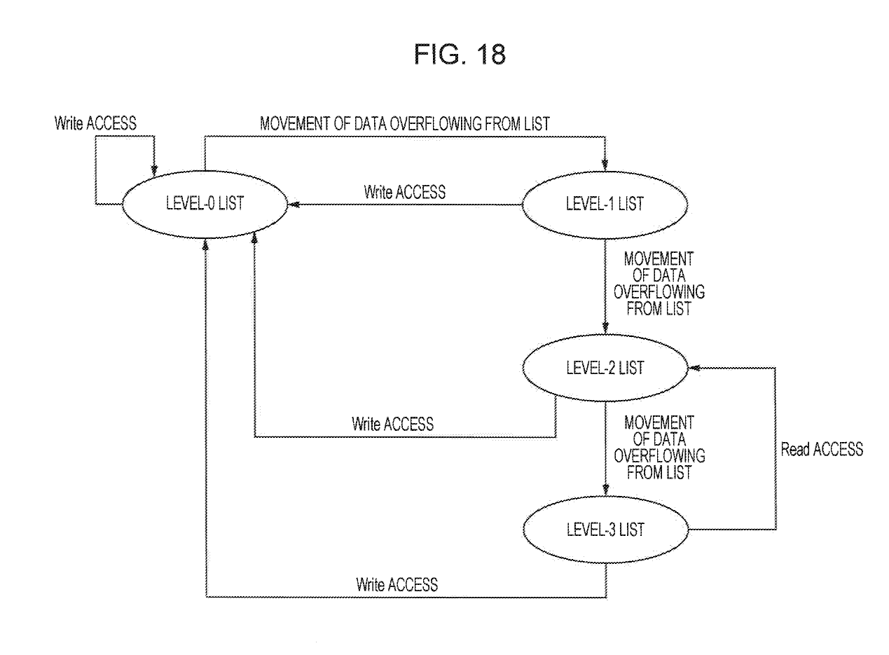

Next, the page movement and the rewriting of the lists associated with the page movement will be described with reference to FIG. 18. A case in which rewriting (Write access) is performed on the pages managed in the level-2 list 316 and a case in which rewriting (Write access) is performed on the pages managed in the level-3 list 317 are basically the same as the case described with reference to FIG. 11, and thus, the description thereof will be omitted.

However, when the rewriting is performed on the pages managed in the level-2 list 316 or the level-3 list 317, the rewritten pages are changed to the paged managed in the level-0 list 418 unlike the case described with reference to FIG. 11.

When the rewriting is performed on the pages managed in the level-1 list 315, the rewritten pages are changed to the pages managed in the level-0 list 418. That is, when the rewriting is performed on the pages managed in the level-1 list 315, the information on the rewritten pages is moved to the tail end of the level-0 list 418 in logical order. In addition, the rewritten pages are moved from the non-volatile storage unit 211 to the high speed saving target area 417 of the volatile storage unit 212.

When rewriting (Write access) is performed on the pages managed in the level-0 list 418, the information on the rewritten pages may be moved to be listed later in logical order. However, a process of moving the page information to another list is not performed. In addition, the page is held without a process of moving the rewritten pages to another storage unit while the page is stored in the high speed saving target area 417 of the volatile storage unit 212.

When level-0 list 418 is full, the information on the pages that may not be stored in the level-0 list 418, that is, the information on the pages that may not be stored because of the capacity of the high speed saving target area 417 of the volatile storage unit 212, is moved to the level-1 list 315.

In this manner, the page that is estimated to have the highest rewriting frequency is stored in the high speed saving target area 417 of the volatile storage unit 212, and the page that is estimated to have the second highest rewriting frequency is stored in the non-volatile storage unit 211. Further, the pages stored in the constant synchronization area 261 of the volatile storage unit 212 are synchronized with the pages stored in the secondary storage device 203. A suspend process of the information processing apparatus 400 which performs such storage will be described.

### Suspend Process in Third Embodiment

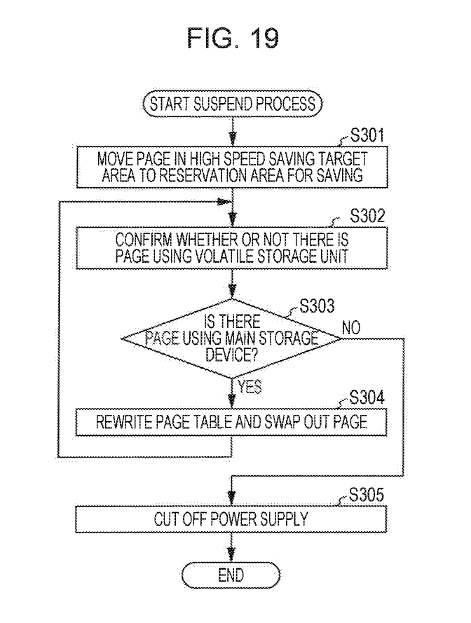

FIG. 19 is a flow chart for illustrating a suspend process of the information processing apparatus 400. In Step S301, the high speed saving processing unit 415 notifies the use of the reservation area for saving 416. The page table management unit 412 invalidates a virtual address mapping the reservation area for saving 416.

The physical memory allocation management unit 413 makes the entire reservation area for saving 416 empty. Next, the high speed saving processing unit 415 copies the page being used in the high speed saving target area 417 to the reservation area for saving 416. When the copy ends, the high speed saving processing unit 415 notifies places of the pages in which the data is moved to the page table management unit 412 and the physical memory allocation management unit 413.

The page table management unit 412 changes the virtual address mapping the movement source page to map the movement destination page. The physical memory allocation management unit 413 sets the pages in the reservation area for saving 416 used as the movement destination to be in use and sets all pages in the high speed saving target area 417 as an empty area.

In Step S302, it is confirmed whether there is a page being used in the volatile storage unit 212. Since the processes from Steps S302 to S305 are performed in the same manner as Steps S101 to S104 illustrated in FIG. 6, the description thereof will be omitted.

When the suspend process starts, the page is saved to the reservation area for saving 416 from the high speed saving target area 417 by executing the process in Step S301. However, since the size of the high speed saving target area 417 (capacity of the pages managed in the level-0 list 418) is sufficiently small, time for saving the page to the reservation area for saving 416 from the high speed saving target area 417 is short. Therefore, it is possible to shorten time for the suspend processing.

Further, even if the high speed saving target area 417 has a certain size, the page is saved to the non-volatile storage unit 211 from the volatile storage unit 212 in the main storage device 202, and thus, time for the saving can be shortened compared to the case in which the page is saved in the secondary storage device 203. Therefore, the fact remains that time for the suspend process can be shortened.

The size of the level-0 list 418 or the size of the saving area thereof (the size of the high speed saving target area 417) is set to a size in which no hindrance occurs even when the data is copied during the suspend process. For example, when settings are provided such that the data can be copied at 100 MB/s and 0.2 seconds for the time that can be spent in the data copy during the suspend process is secured, a size of equal to or smaller than 20 MB is set.

In addition, if an empty area is simply reserved as the reservation area for saving 416, the empty area in the non-volatile storage unit 211 is monopolized and may not be effectively used. Here, the empty area may be used for other applications in a normal operation as long as the area can be released instantly during the suspend process example, the reservation area for saving 416 can be used as a place for a read-only page cache during the normal operation. In this case, since the page cache place is only for reading, the cache is not necessarily saved. Also the page cache place can be released instantly and can be released during the suspend process to be used as the reservation area for saving 416.

### Regarding Other Configurations

In the above-described embodiments, the timing at which the data in the constant synchronization area 261 is written to the secondary storage device 203 is set immediately after the rewriting of the page, but the timing may not be set after the rewriting of the page. For example, the level-2 list 316 may be regularly scanned so that an unsynchronized page is synchronized.

Further, an application can give an explicit instruction for synchronization timing, for example, a timing at which the user completes a specific operation or the like. In addition, the rewriting to the swap area can be prohibited by the application for a specific period of time, or the rewriting can be allowed after the specific period of time

Further, when it is found that a predetermined page has specific rewriting properties, the page may be excluded from a page management target by a list and may be placed in a specific memory at all times. For example, if a predetermined buffer is frequently rewritten, in a case in which an application itself knows the frequent rewriting, the application can request the operating system to hold the page in the non-volatile storage unit 211.

In this manner, according to the present technology, it is possible to shorten time for the suspend process. In addition, a power saving effect can be expected by shortening time for the suspend process.

### Regarding Recording Medium

The above-described series of processes can be executed either by hardware or by software. When the series of processes is executed by software, programs constituting the software are installed in a computer. Here, the computer includes a computer which is built in dedicated hardware or, for example, a general-purpose personal computer in which various programs are installed to execute various functions.

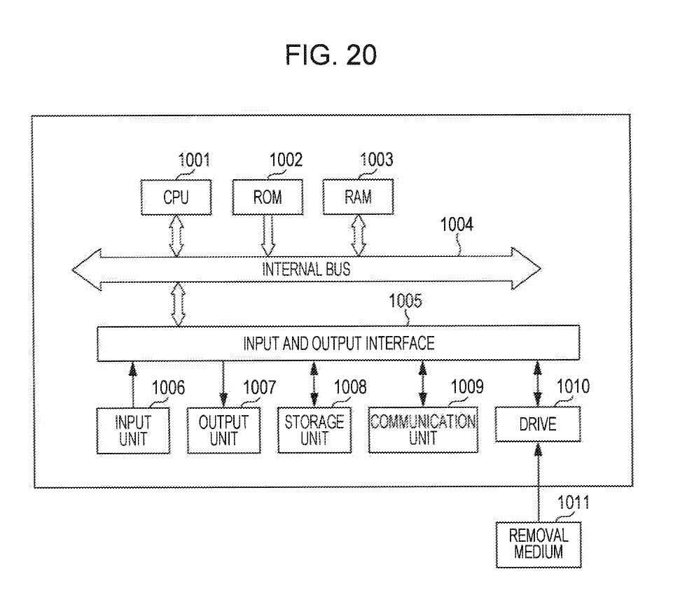

FIG. 20 is a block diagram illustrating a configuration example of hardware of a computer which executes the above-described series of processes by the programs. In the computer, a central process unit (CPU) 1001, a read only memory (ROM) 1002, and a random access memory (RAM) 1003 are connected through a bus 1004. Further, an input, and output interface 1005 is connected to the bus 1004. An input unit 1006, an output unit 1007, a storage unit 1008, a communication unit 1009, and a drive 1010 are connected to the input and output interface 1005.

The input unit 1006 includes a keyboard, a mouse, a microphone, and the like. The output unit 1007 includes a display, a speaker, and the like. The storage unit 1008 includes a hard disk, a non-volatile memory, and the like. The communication unit 1009 includes a network interface and the like. The drive 1010 drives a removable medium 1011 such as a magnetic disk, an optical disc, a magneto-optical disc, a semiconductor memory, and the like.

In the computer having such a configuration, the CPU 1001 executes the above-described series of processes, for example, by loading and executing the program stored in the storage unit 1008 on the RAM 1003 through the input and output interface 1005 and the bus 1004.

For example, the program executed by the computer (the CPU 1001) can be recorded in the removable medium 1011 as a package medium for supply. Further, the program can be supplied through a wired or wireless transmission medium such as a local area network, the Internet, or digital satellite broadcast.

In the computer, the program can be installed on the storage unit 1008 through the input and output interface 1005 by mounting the removable medium 1011 on the drive 1010. In addition, the program can be received by the communication unit 1009 through a wired or wireless transmission medium and can be installed on the storage unit 1008. Further, the program can be installed in advance on the ROM 1002 or the storage unit 1008.

The program executed by the computer may be a program that is processed chronologically in the order described in the specification or a program that is processed in parallel or at a necessary timing when called.

In the specification, the system indicates the entire apparatus including plural apparatuses.

Embodiments of the present technology are not limited to the above-described embodiments, but may be modified in various forms without departing from the gist of the present technology.

The present technology may be configured as follows.

(1) An information processing apparatus including: a main storage device; and a secondary storage device, wherein the main storage device includes a non-volatile storage unit and a volatile storage unit, the volatile storage unit has a synchronization area that is synchronized with a predetermined area of the secondary storage device, and a page placed in the synchronization area is synchronized with the secondary storage device to be stored during an operation of the volatile storage unit.

(2) The information processing apparatus according to (1), wherein the page placed in the synchronization area is a page that is necessary to be saved in the secondary storage device before a suspend process ends.

(3) The information processing apparatus according to (1) or (2), further including a first list for managing pages which are stored in the non-volatile storage unit; and a second list for managing pages which are synchronized with the volatile storage unit and the secondary storage device to be stored.

(4) The information processing apparatus according to (3), further including a third list for managing the pages stored in the secondary storage device.

(5) The information processing apparatus according to (4), wherein the pages are sorted to any one of the first list, the second list, and the third list according to a rewriting frequency with respect to the pages.

(6) The information processing apparatus according to (4), wherein when the page managed in the second list or the third list is rewritten, the rewritten page is changed to the page to be managed in the first list to be moved in the non-volatile storage unit.

(7) The information processing apparatus according to (4), further including a fourth list for managing pages stored in a saving target area, wherein the volatile storage unit has the saving target area for storing a page which is a page having the highest rewriting frequency and is stored in the non-volatile storage unit during a suspend process, and the non-volatile storage unit has an area for saving in which the page stored in the saving target area is stored during the suspend process.

(8) The information processing apparatus according to (7), wherein when a page managed in any one of the first list to the third list is rewritten, the rewritten page is changed to a page managed in the fourth list and moved to the saving target area.

(9) An information processing method of an information processing apparatus that includes a main storage device, and a secondary storage device, the main storage device having a non-volatile storage unit and a volatile storage unit, including providing a synchronization area that is synchronized with a predetermined area of the secondary storage device in the volatile storage unit; and synchronizing a page placed in the synchronization area with the secondary storage device to be stored during an operation of the volatile storage unit.

(10) A computer-recording recording medium having a program recorded therein, the program causing a computer, which controls an information processing apparatus that includes a main storage device, and a secondary storage device, the main storage device having a non-volatile storage unit and a volatile storage unit, to execute a process including providing a synchronization area that is synchronized with a predetermined area of the secondary storage device in the volatile storage unit; and synchronizing a page placed in the synchronization area with the secondary storage device to be stored during an operation of the volatile storage unit.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a main storage device; and
a secondary storage device,
wherein the main storage device includes a non-volatile storage unit and a volatile storage unit,
the volatile storage unit has a synchronization area that is synchronized with a predetermined area of the secondary storage device, and
a page placed in the synchronization area is synchronized with the secondary storage device to be stored during an operation of the volatile storage unit.

2. The information processing apparatus according to claim 1,
wherein the page placed in the synchronization area is a page that is necessary to be saved in the secondary storage device before a suspend process ends.

3. The information processing apparatus according to claim 1, further comprising:
a first list for managing pages which are stored in the non-volatile storage unit; and
a second list for managing pages which are synchronized with the volatile storage unit and the secondary storage device to be stored.

4. The information processing apparatus according to claim 3, further comprising:
a third list for managing the pages stored in the secondary storage device.

5. The information processing apparatus according to claim 4,
wherein the pages are sorted to any one of the first list, the second list, and the third list according to a rewriting frequency with respect to the pages.

6. The information processing apparatus according to claim 4,
wherein when the page managed in the second list or the third list is rewritten, the rewritten page is changed to the page to be managed in the first list to be moved in the non-volatile storage unit.

7. The information processing apparatus according to claim 4, further comprising:
a fourth list for managing pages stored in a saving target area,
wherein the volatile storage unit has the saving target area for storing a page which is a page having the highest rewriting frequency and is stored in the non-volatile storage unit during a suspend process, and
the non-volatile storage unit has an area for saving in Which the page stored in the saving target area is stored during the suspend process.

8. The information processing apparatus according to claim 7,
wherein when a page managed in any one of the first list to the third list is rewritten, the rewritten page is changed to a page managed in the fourth list and moved to the saving target area.

9. An information processing method of an information processing apparatus that includes a main storage device, and a secondary storage device, the main storage device having a non-volatile storage unit and a volatile storage unit, the method comprising:
providing a synchronization area that is synchronized with a predetermined area of the secondary storage device in the volatile storage unit; and
synchronizing a page placed in the synchronization area with the secondary storage device to be stored during an operation of the volatile storage unit.

10. A computer-recording recording medium having a program recorded therein, the program causing a computer, which controls an information processing apparatus that includes a main storage device, and a secondary storage device, the main storage device having a non-volatile storage unit and a volatile storage unit, to execute a process comprising:
providing a synchronization area that is synchronized with a predetermined area of the secondary storage device in the volatile storage unit; and
synchronizing a page placed in the synchronization area with the secondary storage device to be stored during an operation of the volatile storage unit.
